(19) United States
(12) Patent Application Publication
(10) Pub. No.: US 2026/0175903 A1
(43) Pub. Date: Jun. 25, 2026

(54) ANTI-RATTLE DEVICE FOR COMMERCIAL VEHICLES

(71) Applicant: ZF Active Safety and Electronics US LLC, Livonia, MI (US)

(72) Inventors: Jason KINTNER, West Lafayette, IN (US); Kullin ERICKSON, Lafayette, IN (US); Mari CLENDENNING, Lafayette, IN (US)

(21) Appl. No.: 19/000,751

(22) Filed: Dec. 24, 2024

(51) Int. Cl. B62D 5/04

(52) U.S. Cl. CPC B62D 5/0454

(57) ABSTRACT

A worm wheel and a worm shaft are disposed in a cavity of a housing. A first end of the worm shaft is mounted in a bearing and a second end of the worm shaft is couplable to a motor shaft. The housing defines a passage extending perpendicular to the direction of the worm shaft that connects the cavity with an exterior of the housing. A plug bolt is disposed at an opening of the passage, and a spring is disposed in the passage between the plug bolt and a pin. The spring is biased to exert a biasing force on the bearing so as to bias the worm shaft in the direction of the worm wheel in order to keep a plurality of threads of the worm shaft constantly engaged with a plurality of teeth of the worm wheel.

### FIELD

The present disclosure relates to an anti-rattle device for a steering assist system for commercial vehicles.

### BACKGROUND

Steering assemblies of conventional commercial vehicles are often coupled to steering assist systems. Steering assist systems typically provides feedback torque to a steering wheel, allowing a driver to feel a controlled resistance when steering. In order to accomplish this, the steering assist systems integrate various sensors, electronic controls, motorized actuators, all of which work together to simulate natural road feedback based on vehicle speed, steering angle, and other factors. During operation of commercial vehicles, mechanical components of steering assist systems like bearings, bushings, or gear systems develop gaps or play, which causes rattling, especially when commercial vehicles drive over rough surfaces.

### SUMMARY

Embodiments of the present disclosure provide, in a first aspect, a worm gear assembly, comprising: a housing unit having a cavity; a worm wheel rotatably disposed in the cavity of the housing, having a plurality of teeth disposed along a circumference of the worm wheel; a worm shaft disposed in the cavity of the housing, extending in a direction parallel to a plane of the worm wheel and having a thread configured to engage with the plurality of teeth, wherein a first end of the worm shaft is rotatably mounted in a bearing and a second end of the worm shaft is mechanically couplable to a motor shaft, wherein the housing defines a passage extending perpendicular to the direction of the worm shaft and connecting the cavity with an exterior of the housing; a pin disposed in the passage, wherein a first end of the pin is in contact with the bearing; a plug bolt disposed at an opening of the passage; and a spring disposed in the passage between the plug bolt and the pin, the spring biased to exert a force on the bearing away from the plug bolt so as to press the worm shaft in the direction of the worm wheel in order to keep the thread of the worm shaft constantly engaged with the plurality of teeth.

According to an implementation of the first aspect, the worm gear assembly is a part of a steering assist system coupled to an electric powered steering of a commercial vehicle.

According to an implementation of the first aspect, the bearing includes an inner race and an outer race, and wherein the inner race of the bearing is in contact with the worm shaft and the outer race of the bearing is in contact with the first end of the pin.

According to an implementation of the first aspect, the worm shaft rotates along with the inner shaft of the bearing.

According to an implementation of the first aspect, an oval ring is disposed in the cavity and adjacent to the outer race of the bearing.

According to an implementation of the first aspect, the first end of the pin is inserted through an opening in the oval ring such that the first end of the pin is in contact with the bearing.

According to an implementation of the first aspect, a plurality of O-rings are disposed adjacent to the oval ring.

Embodiments of the present disclosure provide, in a second aspect, a method for reducing rattle in a worm gear assembly, comprising: providing a housing unit having a cavity; providing a worm wheel rotatably disposed in the cavity of the housing, having a plurality of teeth disposed along a circumference of the worm wheel; providing a worm shaft disposed in the cavity of the housing, extending in a direction parallel to a plane of the worm wheel and having a thread configured to engage with the plurality of teeth, wherein a first end of the worm shaft is rotatably mounted in a bearing and a second end of the worm shaft is mechanically couplable to a motor shaft, wherein the housing defines a passage extending perpendicular to the direction of the worm shaft and connecting the cavity with an exterior of the housing; disposing a pin in the passage, wherein a first end of the pin is in contact with the bearing; providing a plug bolt disposed at an opening of the passage; and disposing a spring in the passage between the plug bolt and the pin, the spring biased to exert a force on the bearing away from the plug bolt so as to press the worm shaft in the direction of the worm wheel in order to keep the thread of the worm shaft constantly engaged with the plurality of teeth.

According to an implementation of the second aspect, the worm gear assembly is a part of a steering assist system coupled to an electric powered steering of a commercial vehicle.

According to an implementation of the second aspect, the bearing includes an inner race and an outer race, and wherein the inner race of the bearing is in contact with the worm shaft and the outer race of the bearing is in contact with the first end of the pin.

According to an implementation of the second aspect, the worm shaft rotates along with the inner shaft of the bearing.

According to an implementation of the second aspect, an oval ring is disposed in the cavity and adjacent to the outer race of the bearing.

According to an implementation of the second aspect, the first end of the pin is inserted through an opening in the oval ring such that the first end of the pin is in contact with the bearing.

According to an implementation of the second aspect, a plurality of O-rings are disposed adjacent to the oval ring.

### BRIEF DESCRIPTION OF THE DRAWINGS

Embodiments of the present disclosure will be described in greater detail below based on the exemplary figures. The present disclosure is not limited to the exemplary embodiments. All features described and/or illustrated herein can be used alone or combined in different combinations in embodiments of the present disclosure. The features and advantages of various embodiments of the present disclosure will become apparent by reading the following detailed description with reference to the attached drawings which illustrate the following:

FIG. 1 illustrates a perspective view of a steering system within a commercial vehicle coupled to a steering assist system, according to one or more examples of the present disclosure;

FIG. 2 illustrates a perspective view of a steering assist system with a main housing and components of an anti-rattle device;

FIG. 3 illustrates a perspective view of a steering assist system including a worm wheel, worm shaft, and components of an anti-rattle device, according to one or more examples of the present disclosure;

FIG. 4 illustrates a cross-section view of the steering assist system with the anti-rattle device, according to one or more examples of the present disclosure; and

FIG. 5 illustrates a cross-section view of the anti-rattle device for use in the steering assist system, according to one or more examples of the present disclosure.

### DETAILED DESCRIPTION

Examples of the presented application will now be described more fully hereinafter with reference to the accompanying FIGs., in which some, but not all, examples of the application are shown. Indeed, the application may be exemplified in different forms and should not be construed as limited to the examples set forth herein; rather, these examples are provided so that the application will satisfy applicable legal requirements. Where possible, any terms expressed in the singular form herein are meant to also include the plural form and vice versa, unless explicitly stated otherwise. Also, as used herein, the term “a” and/or “an” shall mean “one or more” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on”.

Conventional steering assemblies of commercial vehicles include steering assist systems that improve vehicle control and enhance driving experience. Steering assist systems integrate various sensors, electronic controls, motorized actuators, all of which work together to simulate natural road feedback based on vehicle speed, steering angle, and other factors. Mechanical components of steering assist systems like bearings, bushings, or gear systems develop gaps or play, which causes rattling noise, vibration, and harshness in the steering system and may accelerate wear and tear of the steering assist systems. In some embodiments, the steering assist systems include a worm wheel and a worm shaft. The worm wheel includes a plurality of teeth disposed along the circumference of the worm wheel. The worm shaft includes a thread that are configured to interact with the plurality of teeth of the worm wheel. The design of conventional steering assist systems allows the worm shaft to move freely, leading to conditions where the worm shaft may lose contact with the worm screw. The free movement of the worm shaft leads to rattle in the steering assist systems.

The present disclosure describes using an anti-rattle device to keep the worm shaft in constant contact with the worm wheel of the steering assist systems. Embodiments of the present disclosure describe using a combination of a rotational bearing, a pin, a spring, and a plug to exert a force on the worm shaft, such that the worm shaft is in constant contact with the worm wheel, thereby reducing the rattle of the worm shaft. By installing an anti-rattle device in a steering assist system, existing steering assist systems may be made more durable and provide superior performance and reliability in the operations of a commercial vehicle. The anti-rattle device as installed in the steering assist systems may also reduce the chance of operating noise emission that may develop due to long term wear of gear faces, for example the worm wheel and the worm shaft.

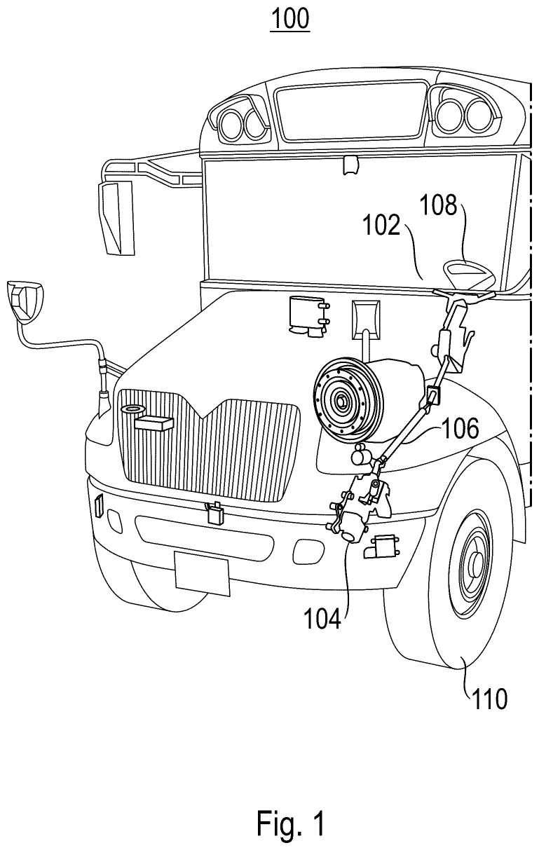

FIG. 1 illustrates a perspective view of a steering system within a commercial vehicle coupled to a steering assist system, according to one or more examples of the present disclosure. Perspective view 100 of FIG. 1, depicts a commercial vehicle 110 including a steering column 102. The steering system 102 includes a steering wheel 108, a steering column 106 and a steering assist system 104. In some embodiments, the steering assist system 104 may be a ReAx (Reaction) module. In some embodiments, the steering assist system 104 may be coupled to a steering gear. The steering gear may be coupled to wheel assemblies of the commercial vehicle 110.

In some embodiments, a steering command received from a driver of the commercial vehicle 110, at the steering wheel 108, is transmitted via the steering column 106 to the steering gear, and to the wheel assemblies of the commercial vehicle 110. In some embodiments, the steering assist system 104 may assist the driver of the commercial vehicle, based on the steering input provided by the driver of the commercial vehicle at the steering wheel 108. For example, the steering assist system may provide a feedback torque to the steering wheel, allowing the driver to feel a controlled resistance when steering.

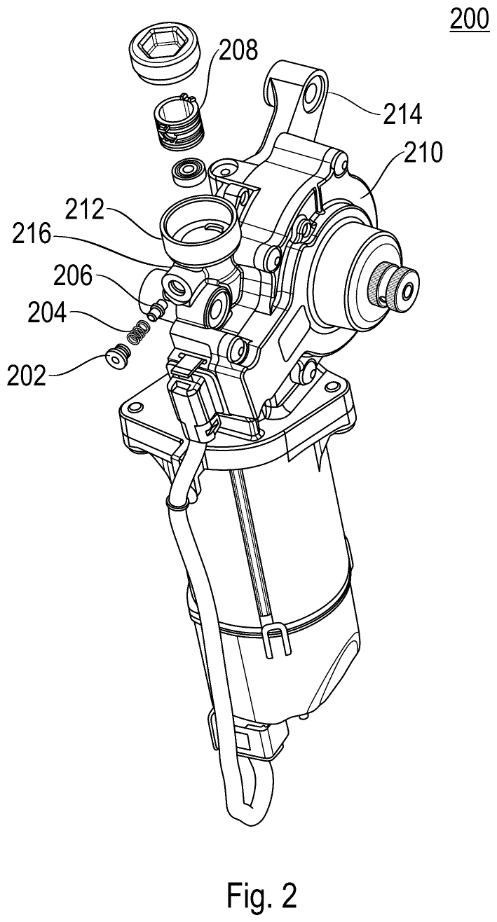

FIG. 2 illustrates a perspective view of a steering assist system with a main housing and components of an anti-rattle device, according to one or more examples of the present disclosure. Perspective view 200 of FIG. 2 depicts a steering assist system 104. For the purposes of this disclosure, we may also refer to the steering assist system as a ReAx module. The steering assist system 104 includes a main housing 214 and a housing cap 210. In some embodiments, a worm wheel and a worm shaft of the steering assist system 104 may be disposed within the main housing 214. A housing cap 210 may be coupled to the main housing 214 to cover the worm wheel.

In some embodiments, the main housing 214 may include openings that allow access to the worm shaft. A first opening 212 of the main housing 214 may allow insertion of a bearing 208. The bearing 208 may be used to surround a first end portion of the worm shaft and may include an inner race and an outer race. In some embodiments, the inner race of the bearing may allow the first end of the worm shaft to rotate, while the outer race remains stationary. A second end (e.g., opposite to the first end) of the worm shaft may be coupled to a motor shaft.

In such embodiments, a second opening 216 of the main housing 214 may create a passage between an exterior of the main housing 214 and an inner cavity of the main housing 214. A pin 206, a spring 204, and a plug 202 may be inserted via the opening 216 within the passage of the main housing 214. In some embodiments, the pin 206 may be disposed such that a first end of the pin 206 is adjacent to the outer race of the bearing 208. The spring 204 may be inserted in the passage created by the opening 216 and disposed over the pin 206, and a plug 202 may be used to close the second opening 216 of the main housing 214. In some embodiments, the plug 202 may compress the spring 204, which in turn may exert a biasing force on the pin 206. The biasing force exerted on the pin 206 may press the pin 206 towards the bearing 208 so as to keep the worm shaft in constant contact with the worm wheel.

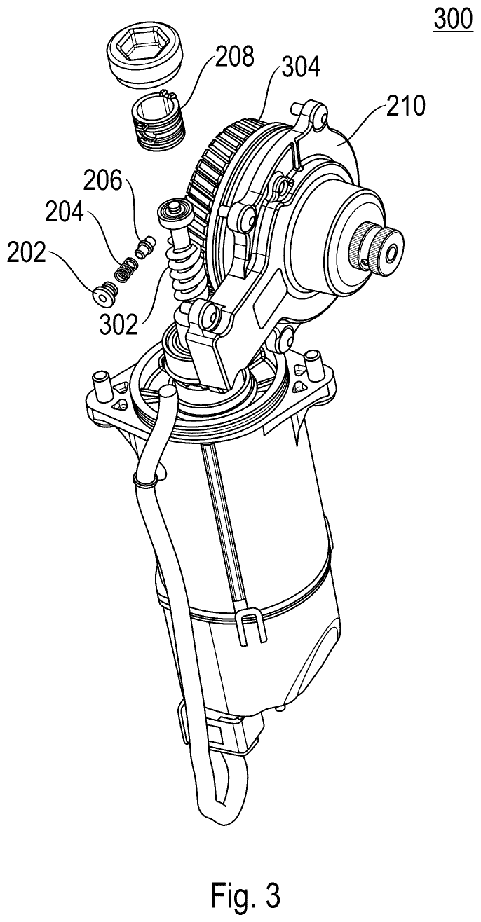

FIG. 3 illustrates a perspective view of a steering assist system including a worm wheel, worm shaft, and components of an anti-rattle device, according to one or more examples of the present disclosure. Perspective view 300 of FIG. 3 depicts a steering assist system 104 after removing the main housing 214 (shown in FIG. 2). A worm shaft 302 and a worm wheel 304, as shown in FIG. 3, may be disposed within the main housing 214 of the steering assist system 104. The housing cap 210 may be used to cover the worm wheel 304.

A bearing 208 may be mechanically coupled to the worm shaft 302. In some embodiments, the bearing 208 may be used to surround a first end portion of the worm shaft 208. The bearing 208 may be used to surround a portion of the worm shaft and may include an inner race and an outer race. A second end (e.g., opposite to the first end) of the worm shaft may be coupled to a motor shaft. In some embodiments, the inner race of the bearing may allow the worm shaft to rotate, while the outer race remains stationary. A pin 206 may be disposed such that a first end of the pin 206 is adjacent to the outer race of the bearing 208. The spring 204 may be disposed over the pin 206, and a plug 202 may be used to hold the spring 204, pin 206, and bearing 208 in place. In some embodiments, the plug 202 may be used to close the second opening 216 of the main housing 214 (as shown in FIG. 2). In some embodiments, the plug 202 may compress the spring 204, which in turn may exert a biasing force on the pin 206. The biasing force exerted on the pin 206 may press the pin 206 towards the bearing 208 so as to keep the worm shaft in constant contact with the worm wheel.

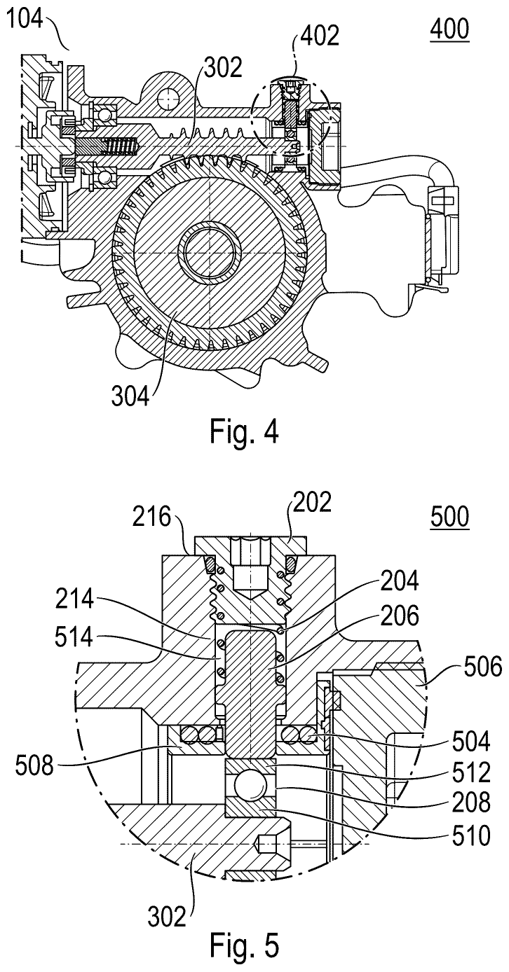

FIG. 4 illustrates a cross-section view of the steering assist system with the anti-rattle device, according to one or more examples of the present disclosure. Cross-section view 400 of the steering assist system 104 depicts a worm wheel 304 and a worm shaft 302. As shown in FIG. 4, the worm wheel 304 has a plurality of teeth disposed along a circumference of the worm wheel 304. The teeth disposed on the circumference of the worm wheel 304 engage with thread of the worm shaft 302. During operation of the commercial vehicle, the thread of the worm shaft 302 may disengage from the teeth of the worm wheel 304. The disengaging of the worm shaft 302 from the worm wheel 304 may also lead to noise during the operation of the steering assist system 104. An anti-rattle device 402 may be used to exert a force on the worm shaft 302 so that the thread of the worm shaft 302 are in constant contact with corresponding teeth of the worm wheel 304. The anti-rattle device 402 is described in detail with respect to FIG. 5.

FIG. 5 illustrates a cross-section view of the anti-rattle device for use in the steering assist system, according to one or more examples of the present disclosure. Cross-section view 500 depicts an anti-rattle device as integrated with the main housing 214 of the steering assist system 104. An opening 216 in the main housing 214 creates a passage 514 that extends from an edge of the main housing 214 to an internal cavity of the main housing 214 where the worm shaft 302 is disposed. In some embodiments, the passage 514 may connect an exterior of the main housing 214 to the internal cavity of the main housing 214. In some embodiments, the components of the anti-rattle device 402 may be included within the passage 514. The anti-rattle device 402 may include a bearing 208, a pin 206, a spring 204, and a plug 202.

The bearing 208 of the anti-rattle device 402 surrounds a first end portion of the worm shaft 302. In some embodiments, the bearing 208 has an inner race 510 and an outer race 512. The inner race 510 allows the first end of the worm shaft 302 to rotate while the outer race 512 remains stationary. The bearing 208 may be surrounded by an oval ring (e.g., clam shell) 508. The clam shell 508 may be used to couple the anti-rattle device 402 with an end plug 506 of the steering assist system 104. Additionally, O-ring bands 504 may be used to hold the clam shell 508 in place.

A pin 206 may be disposed in the passage 514. In some embodiments, the pin 206 may be inserted through an opening in the clam shell 508 so that a first end of the pin may be disposed adjacent to the outer race 512 of the bearing 208. The spring 204 may be disposed in the passage 514 over the pin 206, and a plug 202 may be used to close the opening 216 of the passage 514. In some embodiments, the plug 202 may compress the spring 204, which in turn may exert a biasing force on the pin 206. The biasing force exerted on the pin 206 may press pin 206 towards the bearing 208 so as to keep the worm shaft in constant contact with the worm wheel.

While subject matter of the present disclosure has been illustrated and described in detail in the drawings and foregoing description, such illustration and description are to be considered illustrative or exemplary and not restrictive. Any statement made herein characterizing the present disclosure is also to be considered illustrative or exemplary and not restrictive as the present disclosure is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A worm gear assembly, comprising:
a housing unit having a cavity;
a worm wheel rotatably disposed in the cavity of the housing, having a plurality of teeth disposed along a circumference of the worm wheel;
a worm shaft disposed in the cavity of the housing, extending in a direction parallel to a plane of the worm wheel and having a thread configured to engage with the plurality of teeth, wherein a first end of the worm shaft is rotatably mounted in a bearing and a second end of the worm shaft is mechanically couplable to a motor shaft, wherein the housing defines a passage extending perpendicular to the direction of the worm shaft and connecting the cavity with an exterior of the housing.

2. The worm gear assembly of claim 1, wherein the worm gear assembly is a part of a steering assist system coupled to an electric powered steering of a commercial vehicle.

3. The worm gear assembly of claim 1, wherein the bearing includes an inner race and an outer race, and wherein the inner race of the bearing is in contact with the worm shaft and the outer race of the bearing is in contact with the first end of the pin.

4. The worm gear assembly of claim 3, wherein the worm shaft rotates along with the inner shaft of the bearing.

5. The worm gear assembly of claim 4, wherein an oval ring is disposed in the cavity and adjacent to the outer race of the bearing.

6. The worm gear assembly of claim 5, wherein the first end of the pin is inserted through an opening in the oval ring such that the first end of the pin is in contact with the bearing.

7. The worm gear assembly of claim 6, wherein a plurality of O-rings are disposed adjacent to the oval ring.

8. A method of reducing rattle in a worm gear assembly, comprising:
providing a housing unit having a cavity;
providing a worm wheel rotatably disposed in the cavity of the housing, having a plurality of teeth disposed along a circumference of the worm wheel;
providing a worm shaft disposed in the cavity of the housing, extending in a direction parallel to a plane of the worm wheel and having a thread configured to engage with the plurality of teeth, wherein a first end of the worm shaft is rotatably mounted in a bearing and a second end of the worm shaft is mechanically couplable to a motor shaft, wherein the housing defines a passage extending perpendicular to the direction of the worm shaft and connecting the cavity with an exterior of the housing;
disposing a pin in the passage, wherein a first end of the pin is in contact with the bearing;
providing a plug bolt disposed at an opening of the passage; and
disposing a spring in the passage between the plug bolt and the pin, the spring biased to exert a force on the bearing away from the plug bolt so as to press the worm shaft in the direction of the worm wheel in order to keep the thread of the worm shaft constantly engaged with the plurality of teeth.

9. The method of claim 8, wherein the worm gear assembly is a part of a steering assist system coupled to an electric powered steering of a commercial vehicle.

10. The method of claim 8, wherein the bearing includes an inner race and an outer race, and wherein the inner race of the bearing is in contact with the worm shaft and the outer race of the bearing is in contact with the first end of the pin.

11. The method of claim 10, wherein the worm shaft rotates along with the inner shaft of the bearing.

12. The method of claim 11, wherein an oval ring is disposed in the cavity and adjacent to the outer race of the bearing.

13. The method of claim 12, wherein the first end of the pin is inserted through an opening in the oval ring such that the first end of the pin is in contact with the bearing.

14. The method of claim 13, wherein a plurality of O-rings are disposed adjacent to the oval ring.
